(19) United States
(12) Patent Application Publication
(10) Pub. No.: US 2025/0093513 A1
(43) Pub. Date: Mar. 20, 2025

(54) IDENTIFICATION SYSTEM, IDENTIFICATION METHOD, AND STORAGE MEDIUM

(71) Applicant: NEC Corporation, Minato-ku, Tokyo (JP)

(72) Inventor: Katsuhiro YUTANI, Tokyo (JP)

(73) Assignee: NEC Corporation, Minato-ku, Tokyo (JP)

(21) Appl. No.: 18/730,829

(22) PCT Filed: Jan. 25, 2022
(86) PCT No.: PCT/JP2022/002672

§ 371 Date: Jul. 22, 2024

(51) Int. Cl. G01S 17/89; G01S 17/42; G01S 17/58

(52) U.S. Cl. CPC G01S 17/89; G01S 17/42; G01S 17/58

(57) ABSTRACT

The identification system includes: an acquisition circuit that, on the basis of a laser beam emitted to a plurality of positions within a target space including the still structure and reflected beams from the laser beams, acquires position information based on the positions and wavelength information based on the wavelength of the reflected beams that were reflected off of the positions; an identification circuit that identifies, on the basis of the wavelength information and from among the plurality of positions, a moving body position where a moving body is present; and a monitoring setting circuit that sets, from among the plurality of positions, the positions other than the moving body position to be monitored.

### TECHNICAL FIELD

The present invention relates to, for example, an identification system that enables monitoring of a stationary structure.

### BACKGROUND ART

A technique for monitoring a structure by using Light Detection and Ranging (LiDAR) is known. PTL 1 and PTL 2 disclose contents related to this technique. PTL 1 discloses a technique of detecting whether an abnormality occurs in a structure by detecting a vibration speed of the structure by using a laser speedometer. It is noted that a technique described in PTL 2 is also known as a related art.

### CITATION LIST

### Patent Literature

PTL 1: Japanese Unexamined Patent Application Publication No. 2001-215148
PTL 2: Japanese Unexamined Patent Application Publication No. 2020-507749

### SUMMARY OF INVENTION

### Technical Problem

In general, an object that is moving (hereinafter referred to as a “moving object”) may be present inside or around a structure that is supposed to be stationary (hereinafter referred to as a “stationary structure”). In such a case, the moving object becomes noise in monitoring the stationary structure. Therefore, in monitoring of the stationary structure, it is preferable to exclude these moving objects from a target of monitoring.

However, the technique described in PTL 1 does not have a means for excluding a moving object from the target of monitoring. Therefore, with the technique described in PTL 1, it is difficult to exclude a moving object from the target of monitoring. As a result, there is a problem that it is difficult to avoid noise associated with the moving object from being mixed into a result of monitoring.

In view of the above-mentioned problem, an object of the present invention is to restrain, in monitoring of a stationary structure, noise associated with a moving object from being mixed into a result of monitoring.

### Solution to Problem

The present invention is an identification system including:
an acquisition means for acquiring, based on laser light emitted to a plurality of positions within a target space including a stationary structure and reflected light of the laser light, position information according to the positions and wavelength information based on a wavelength of the reflected light reflected at the positions;
an identification means for identifying, based on the wavelength information, a moving object position where a moving object is present among the plurality of positions; and
a monitoring setting means for setting, to a target of monitoring, the positions other than the moving object position among the plurality of positions.

The present invention is an identification method including:
acquiring, based on laser light emitted to a plurality of positions within a target space including a stationary structure and reflected light of the laser light, position information according to the positions and wavelength information based on a wavelength of the reflected light reflected at the positions;
identifying, based on the wavelength information, a moving object position where a moving object is present among the plurality of positions; and
setting, to a target of monitoring, the positions other than the moving object position among the plurality of positions.

Also, the present invention is a storage medium storing a program that causes an information processing apparatus to execute:
processing of acquiring, based on laser light emitted to a plurality of positions within a target space including a stationary structure and reflected light of the laser light, position information according to the positions and wavelength information based on a wavelength of the reflected light reflected at the positions;
processing of identifying, based on the wavelength information, a moving object position where a moving object is present among the plurality of positions; and
processing of setting, to a target of monitoring, the positions other than the moving object position among the plurality of positions.

### Advantageous Effects of Invention

According to the present invention, in monitoring of a stationary structure, noise associated with a moving object can be restrained from being mixed into a result of monitoring.

### BRIEF DESCRIPTION OF DRAWINGS

FIG. 1 is a block diagram illustrating a configuration example of an identification system according to a first example embodiment of the present invention.

FIG. 2 is a diagram for explaining details of the identification system according to the first example embodiment of the present invention.

FIG. 3 is a diagram for explaining details of the identification system according to the first example embodiment of the present invention.

FIG. 4 is a diagram for explaining details of the identification system according to the first example embodiment of the present invention.

FIG. 5 is a flowchart illustrating an example of operations of the identification system according to the first example embodiment of the present invention.

FIG. 6 is a block diagram illustrating a configuration example of the identification system according to the second example embodiment of the present invention.

FIG. 7 is a flowchart illustrating an example of operations of the identification system according to the second example embodiment of the present invention.

FIG. 8 is a block diagram illustrating a configuration example of an identification system according to a third example embodiment of the present invention.

FIG. 9 is a flowchart illustrating an example of operations of the identification system according to the third example embodiment of the present invention.

FIG. 10 is a diagram illustrating an example of an information processing apparatus that achieves an identification system and the like according to the first, second, and third example embodiments of the present invention.

### EXAMPLE EMBODIMENT

### First Example Embodiment

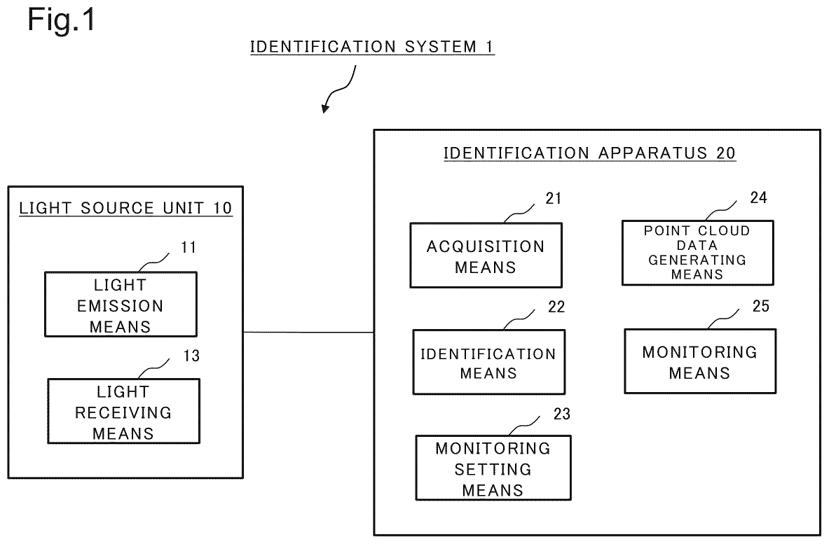

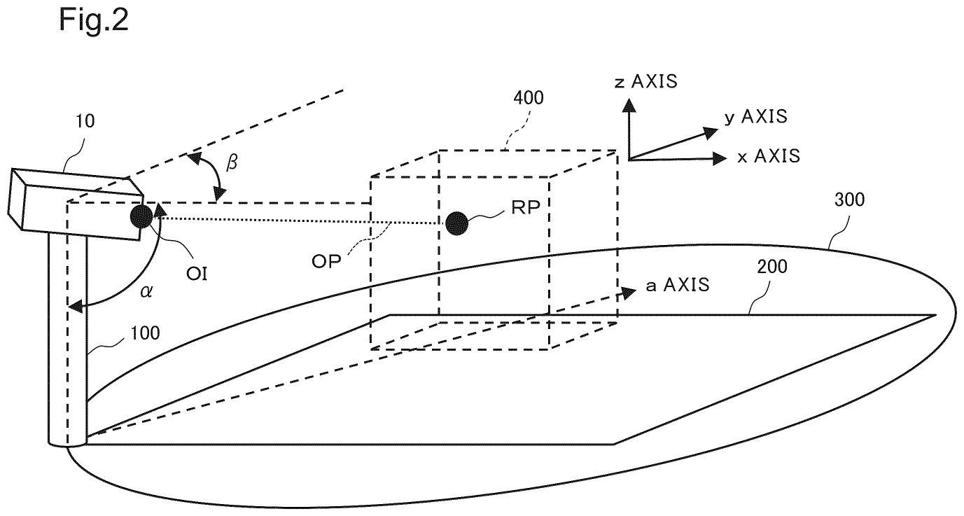

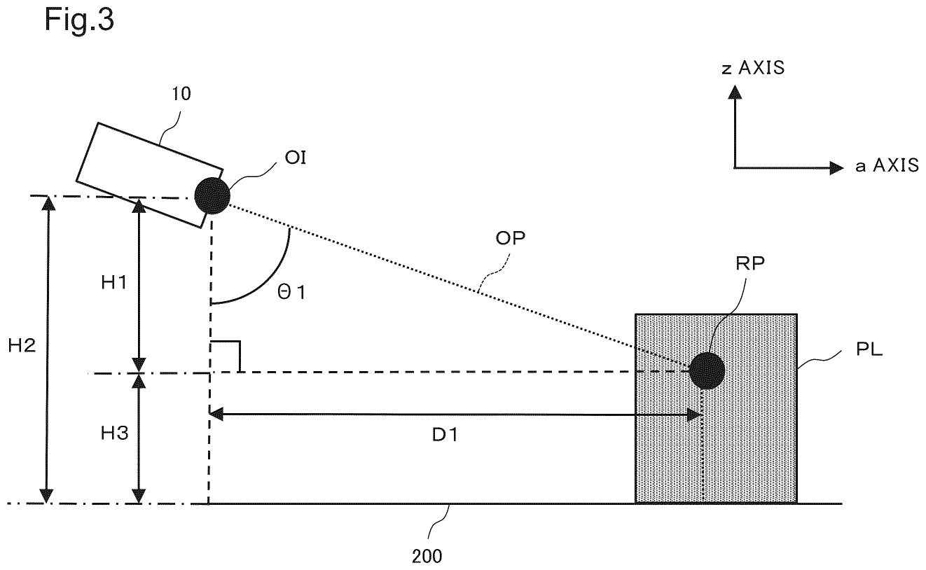

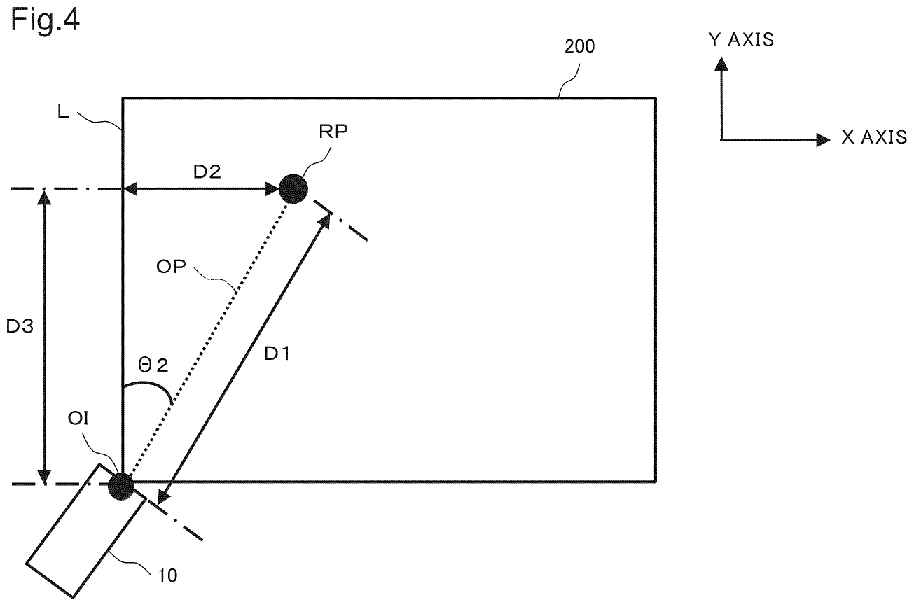

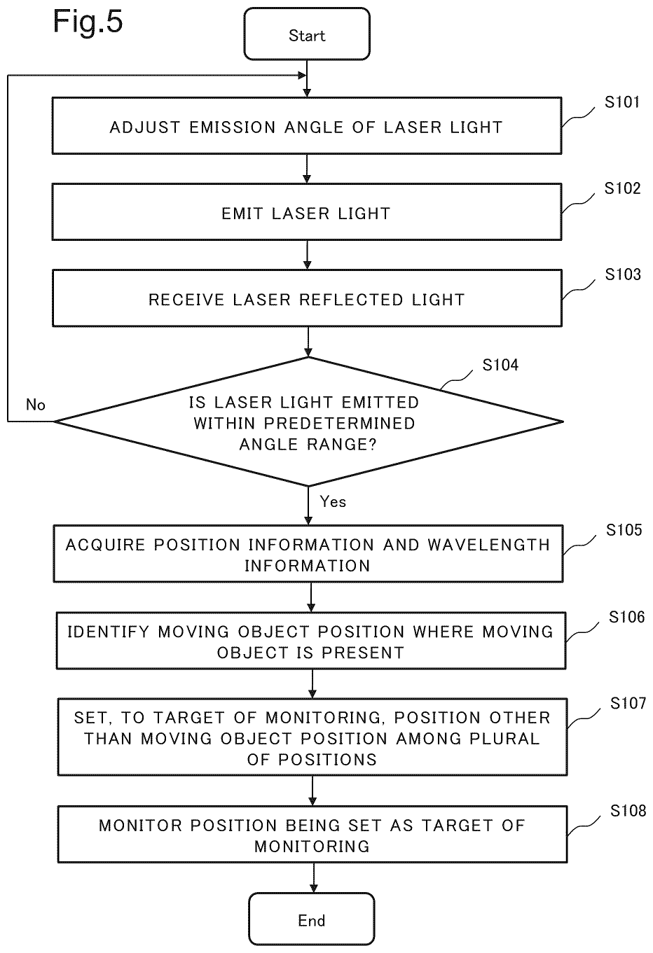

An identification system 1 according to the first example embodiment is explained with reference to FIG. 1, FIG. 2, FIG. 3, FIG. 4, and FIG. 5. FIG. 1 is a block diagram illustrating a configuration example of the identification system 1. FIG. 2, FIG. 3, and FIG. 4 are diagrams for explaining details of the identification system 1. FIG. 5 is a flowchart for explaining an example of operations of the identification system 1.

The configuration of the identification system 1 is explained. The identification system 1 includes a light source unit 10 and an identification apparatus 20. In FIG. 1, the light source unit 10 and the identification apparatus 20 are provided separately, but may be provided integrally. The light source unit 10 and the identification apparatus 20 can communicate with each other.

The light source unit 10 includes light emission means 11 and light receiving means 13.

The light emission means 11 irradiates a light emission area 300 including a target space 200 in which a stationary structure 400 is arranged with laser light. Specifically, the laser light is pulsed laser light. For example, the light emission means 11 emits laser light from an optical input/output terminal OI provided in the light source unit 10, as illustrated in FIG. 2, FIG. 3, and FIG. 4. As a result, the emitted laser light propagates along an optical path OP and enters a reflection point RP of the target object that is present in the target space 200. The optical path OP is a line segment connecting the optical input/output terminal OI and the reflection point RP. In this case, the target space is a space that includes the stationary structure 400 such as a building. Note that stationary structures 400 is a structure such as a building, a steel tower, a bridge, a utility pole, and the like that is fixed to the land.

Further, the light receiving means 13 receives the laser light reflected by the stationary structure 400 within the target space 200. Hereinafter, the “laser light reflected by the stationary structure 400 in the target space 200” is referred to as “laser reflected light”. For example, in the examples of FIG. 2, FIG. 3 and FIG. 4, the light receiving means 13 receives the laser reflected light from the reflection point RP of the stationary structure 400 through the optical path OP and the optical input/output terminal OI. Furthermore, by changing the direction in which the light source unit 10 emits the laser light as described later, the light receiving means 13 can receive laser reflected light from different reflection points RP.

Next, the identification apparatus 20 is explained. The identification apparatus 20 includes acquisition means 21, identification means 22, monitoring setting means 23, point cloud data generating means 24, and monitoring means 25. The acquisition means 21, the identification means 22, the monitoring setting means 23, the point cloud data generating means 24, and the monitoring means 25 may be provided in a single apparatus or may be provided in different apparatuses.

The acquisition means 21 is explained. The acquisition means 21 acquires position information corresponding to each position irradiated with the laser light, based on the laser light and laser reflected light. Furthermore, the acquisition means 21 acquires wavelength information corresponding to the wavelength of the laser reflected light reflected at each position irradiated with the laser light, based on the laser light and the laser reflected light. In this case, the laser reflected light refers to the reflected light of the laser light emitted to each position of the target space 200 including the stationary structure 400.

In this case, position information is explained with reference to FIG. 2, FIG. 3, and FIG. 4. FIG. 2 illustrates positional relationship between the light source unit 10 and the target space 200 along x, y, and z axes. Furthermore, FIG. 3 illustrates the positional relationship between the light source unit 10 and the target space 200 along the z-axis and the a-axis. The a-axis is acquired by orthogonally projecting the optical path OP onto the xy plane.

By tilting the light source unit 10 along α direction (vertical direction with respect to the xy plane) illustrated in FIG. 2, the light emission means 11 can emit laser light at a given angle θ1 as illustrated in FIG. 3. For example, as illustrated in FIG. 3, the angle θ1 is an angle formed by a straight line extending vertically downward from the optical input/output terminal OI of the laser light and the optical path OP. The acquisition means 21 can detect the angle θ1 using a gyro sensor (not illustrated) or the like.

The acquisition means 21 calculates the length of the optical path OP from the time from when the laser light is emitted by the light emission means 11 until the laser reflected light is received by the light receiving means 13. Hereinafter, “a time until the laser reflected light is received by the light receiving means 13” is referred to as a “time t”. Specifically, the length of the optical path OP is found by multiplying the time t by the speed of light and dividing the acquired value by two. The acquisition means 21 can calculate a difference between the z-coordinate of the optical input/output terminal OI of the laser light and the z-coordinate of the reflection point RP of the laser light (H1 in FIG. 3) by multiplying the length of the optical path OP by cos θ1. Accordingly, the acquisition means 21 acquires the relative position of the reflection point RP on the z-axis with respect to the optical input/output terminal OI.

Furthermore, the acquisition means 21 calculates the length of the line segment D1 of the optical path OP projected onto the xy plane by multiplying the length of the optical path OP by sin θ1. As illustrated in FIG. 4, the line segment D1 is a line segment that connects the optical input/output terminal OI of the laser light to the reflection point RP on the xy plane.

By tilting the light source unit 10 along β direction (parallel to the xy plane) illustrated in FIG. 2, the light emission means 11 can emit laser light at any given angle θ2. For example, the angle θ2 is an angle formed by a reference line L set on the xy plane and the optical path OP, as illustrated in FIG. 4. In the example illustrated in FIG. 4, the reference line L is one of the sides forming the outer periphery of the target space 200. The acquisition means 21 can detect the angle θ2 using a gyro sensor (not illustrated) or the like.

The acquisition means 21 calculates a difference between the x-coordinate of optical input/output terminal OI and the x-coordinate of the reflection point RP (D2 in FIG. 4) by multiplying the length of line segment D1 by sin θ2. The acquisition means 21 also calculates a difference between the y-coordinate of the optical input/output terminal OI and the y-coordinate of the reflection point RP (D3 in FIG. 4) by multiplying the length of the line segment D1 by cos θ2. As a result, the acquisition means 21 acquires the relative position on the x-axis and the relative position on the y-axis of the reflection point RP with respect to the optical input/output terminal OI. The acquisition means 21 stores the acquired relative positions on the respective axes in association with the angles θ1 and θ2.

By changing at least one of the angles θ1 and θ2 by the light source unit 10, the laser light is incident on the reflection point RP at a different position. The light source unit 10 receives the reflected laser light from plurality of reflection points RP within the light emission area 300 by emitting laser light according to plurality of angles θ1 and plurality of angles θ2 defined in advance. Thereby, the acquisition means 21 can acquire the relative positions on the respective axes for each of the plurality of reflection points RP in the target space 200. The acquisition means 21 acquires the relative positions on the respective axes of each of the reflection points RP acquired as described above as position information. Note that the acquisition means 21 may convert the relative positions into absolute positions using a predetermined reference point, and acquire the absolute positions as position information.

Next, wavelength information is explained. The wavelength information is information that indicates the difference between the wavelength of laser light and the wavelength of laser reflected light. When the laser light enters the moving reflection point RP, the wavelength of the reflected laser light changes due to the Doppler effect. That is, the wavelength information is information indicating the amount of wavelength shift due to the Doppler effect.

The light receiving means 13 detects the wavelength of the laser reflected light by coherently detecting the laser reflected light using local light having the same wavelength as the laser light. When the light receiving means 13 receives the reflected light from the reflection point RP, the light receiving means 13 notifies the acquisition means 21 of the wavelength of the reflected light. Furthermore, the acquisition means 21 stores in advance the wavelength of the laser light emitted by the light emission means 11. Thereby, the acquisition means 21 can acquire the wavelength information according to the wavelength of the reflected light. The acquisition means 21 outputs the position information and the wavelength information, which are acquired, to the identification means 22.

The identification means 22 identifies the moving object position where a moving object is present among plurality of positions based on the wavelength information.

Specifically, the identification means 22 identifies, among the positions according to the position information, a position of reflection of the reflected light of which the wavelength is equal to or more than a threshold away from the wavelength of the laser light, as a moving object position where a moving object is present. Generally, in a case where a moving object moves between the stationary structure 400 such as a steel tower and the light emission means 11, the wavelength of the light reflected at the position of the moving object changes due to the Doppler effect. Accordingly, the identification means 22 can identify the position of reflection of the reflected light of which the wavelength is equal to or more than a threshold away from the wavelength of the laser light, as a moving object position where a moving object is present. The identification means 22 outputs information indicating the position of the moving object position to the monitoring setting means 23.

The monitoring setting means 23 sets the target of monitoring to a position other than the moving object position from among plurality of positions where the laser light is reflected. Specifically, the monitoring setting means 23 determines that the moving object is located at a moving object position identified by the identification means 22. Then, the monitoring setting means 23 determines that the stationary structure 400 is present at a position other than the moving object position from among plurality of positions where the laser light is reflected. Furthermore, the monitoring setting means 23 sets the target of monitoring to the position where the stationary structure 400 is present. That is, the monitoring setting means 23 excludes the position where the moving object is present from the target of monitoring, and sets the target of monitoring to the position where the stationary structure 400 is present.

The point cloud data generating means 24 generates point cloud data, which is a set of points corresponding to positions other than the moving object position, from among plurality of positions where the laser light is reflected. For example, the point cloud data is a three-dimensional model. Specifically, the point cloud data generating means 24 may generate, from among plurality of positions where the laser light is reflected, a three-dimensional model of the target space 200 using position information according to positions other than the moving object position. The three-dimensional model is a collection of points whose positions are uniquely determined by the x-axis coordinates, y-axis coordinates, and z-axis coordinates. The point cloud data generating means 24 generates a model indicating the shape of the stationary structure 400 in the target space 200 by plotting plurality of reflection points RP on the three-dimensional model, based on the relative positions of the reflection points RP with respect to an optical input/output terminal O1. The relative positions of the reflection points RP with respect to the optical input/output terminal O1 are acquired by the acquisition means 21. As a result, the model generated by the point cloud data generating means 24 is a set of points corresponding to positions other than the moving object position, and accordingly the model only shows stationary objects without showing moving objects.

The monitoring means 25 monitors the position that is set as the target of monitoring by monitoring setting means 23. Specifically, for example, the point cloud data generating means 24 continuously executes the process of generating point cloud data. The monitoring means 25 generates the three-dimensional model of the stationary structure 400 using the generated point cloud data. That is, such a three-dimensional model is generated in so-called “real time”. The monitoring means 25 displays an image including the generated three-dimensional model on a display (not illustrated). As a result, monitoring of the stationary structure 400 is realized.

At this time, the monitoring means 25 displays a point cloud model that only shows the stationary structure 400 without showing the moving object. This allows the moving object to be excluded from the target of monitoring. As a result, in monitoring of the stationary structure 400, noise corresponding to the moving object can be restrained from being mixed into the result of monitoring. Furthermore, by including the stationary objects in the target of monitoring, monitoring of the stationary structures 400 can be realized.

By using the laser light and corresponding reflected light for sensing (i.e., by using LiDAR device), not only the position of an object included in the target space 200 but also whether the object is a stationary object or a moving object can be detected. That is, the detection of the position of each object and the detection of the movement of each object can be realized using the same device (i.e., LiDAR device). This makes it possible to reduce the number of detection devices included in the system compared to the case where different devices are used to detect the position of each object and the movement of each object. As a result, the identification system 1 has a simplified system configuration.

In a case where a camera is used instead of a LiDAR device and image recognition is used to detect individual objects and the movement of individual objects, machine learning is required in advance from the perspective of realizing such image recognition. On the other hand, by using a LiDAR device, such machine learning can be made unnecessary. Additionally, the time required for image recognition processing is usually longer than the time required for processing to generate point cloud data. Therefore, by using a LiDAR device, processing time can be reduced compared to using image recognition.

Next, an example of operations of the identification system 1 is explained with reference to FIG. 5.

The light source unit 10 adjusts the emission angle of the laser light (S101). For example, the light source unit 10 adjusts the angle θ1 illustrated in FIG. 3 and the angle θ2 illustrated in FIG. 4 to predetermined angles.

The light emission means 11 of the light source unit 10 emits laser light (S102). As a result, the laser light is reflected at the reflection point RP of the stationary structure 400.

The light receiving means 13 of the light source unit 10 receives laser reflected light (S103). At this time, in a memory (not illustrated) provided in the identification apparatus 20, a time t from when the laser light is emitted to when the reflected laser light is received is stored in association with the emission angle of the laser light. In this case, the light source unit 10 stores the intensity of the reflected laser light in addition to the time t.

The light source unit 10 determines whether the laser light is emitted within a predetermined angle range (S104).

In a case where the laser light is not emitted within the predetermined angle range (No in S104), the light source unit 10 adjusts the emission angle of the laser light (S101). For example, the light source unit 10 changes at least one of the angle θ1 illustrated in FIG. 3 and the angle θ2 illustrated in FIG. 4.

In a case where the laser light is emitted in the predetermined angle range (Yes in S104), the acquisition means 21 acquires, based on laser reflected light, position information corresponding to each position irradiated with laser light and the wavelength information based on the wavelength of reflected light reflected at each position (S105).

The identification means 22 identifies, based on the wavelength information, the moving object position where the moving object is present from among the plurality of positions (S106). The monitoring setting means 23 sets the target of monitoring to a position other than the position identified as the moving object position from among the plurality of positions (S107). The monitoring means 25 monitors the position that is set as the target of monitoring (S108).

Specifically, the monitoring means 25 displays, on a display (not illustrated), the point cloud data generated between S107 and S108 by the point cloud data generating means 24. Note that in the above example, the monitoring means 25 monitors the stationary structure 400 using point cloud data, but the monitoring means 25 may perform monitoring using a method that does not use point cloud data. Specifically, the monitoring means 25 may perform monitoring by continuing to extract, to the outside, only position information identified as the target of monitoring from among the position information corresponding to each point in the target space 200.

The identification system 1 has been hereinabove explained. In the identification system 1, the acquisition means 21 acquires, based on the reflected light of the laser light emitted to each position in the target space 200 including the stationary structure 400, the position information corresponding to each position and the wavelength information based on the wavelength of the reflected light reflected at each position. Furthermore, the identification means 22 identifies, based on the wavelength information, the moving object position where the moving object is present from among plurality of positions where the laser light is reflected. In addition, the monitoring setting means 23 sets the target of monitoring to a position other than the moving object position from among plurality of positions where the laser light is reflected.

As described above, according to the identification system 1, moving objects can be excluded from the target of monitoring. As a result, in monitoring of the stationary structure 400, noise corresponding to the moving object can be restrained from being mixed into the result of monitoring. Furthermore, by including stationary objects in the target of monitoring, monitoring of the stationary structures 400 can be realized.

### Second Example Embodiment

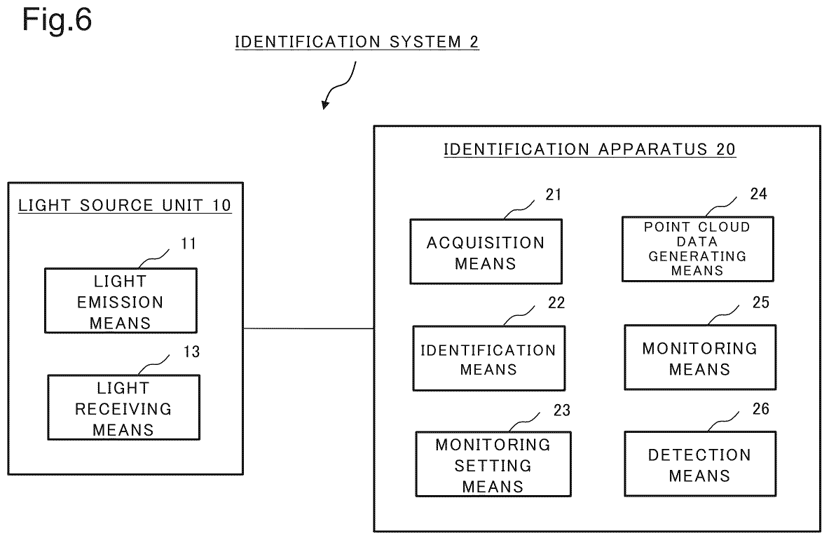

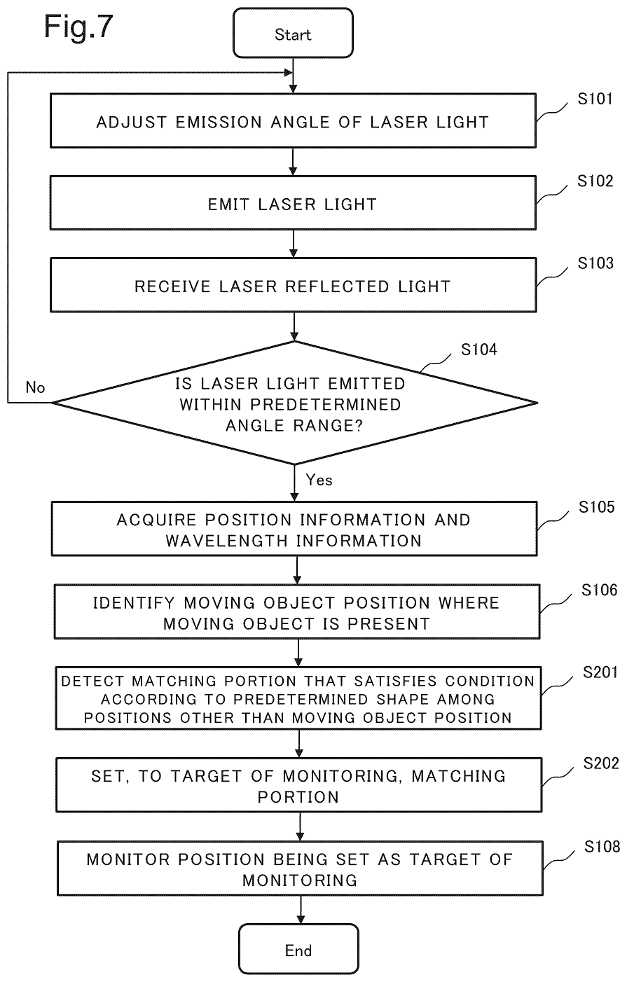

An identification system 2 according to the second example embodiment is explained with reference to FIG. 6 and FIG. 7. FIG. 6 is a block diagram illustrating a configuration example of the identification system 2. FIG. 7 is a flowchart illustrating an example of operations of the identification system 2.

As illustrated in FIG. 6, the identification system 2 includes light source unit 10 and identification apparatus 20. The constituent elements of the identification system 2 may have configurations, connection relationships, and functions similar to the constituent elements of the identification system 1 denoted with similar reference numerals. For example, the light source unit 10 and the identification apparatus 20 of the identification system 2 may have configurations, connection relationships, and functions similar to the light source unit 10 and the identification apparatus 20 of the identification system 1.

The identification apparatus 20 includes acquisition means 21, identification means 22, monitoring setting means 23, point cloud data generating means 24, monitoring means 25, and detection means 26. The identification apparatus 20 of the identification system 2 differs from the identification apparatus 20 of the identification system 1 in that the identification apparatus 20 of the identification system 2 further includes the detection means 26.

The detection means 26 detects a matching portion that satisfies a condition according to a predetermined shape from among positions other than the moving object position among the positions where the laser reflected light is reflected. The detection means 26 detects point clouds for individual objects from among point clouds included in the point cloud data generated by the point cloud data generating means 24.

Specifically, for example, the detection means 26 uses the generated point cloud data to perform processes to calculate the distance between points and to detect individual surfaces (including flat and curved surfaces). The detection means 26 groups point clouds included in the point cloud data by objects based on the results of these processes. As a result, point clouds corresponding to individual objects are detected. In other words, point cloud data corresponding to each object is generated. The generated point cloud data indicates the position and shape of each object.

In this way, the detection means 26 detects a matching portion that satisfies the condition according to the predetermined shape from among positions other than the moving object position among the positions where the laser reflected light is reflected. Note that the condition according to the predetermined shape refers to the above-mentioned calculated distance between points and information indicating each detected surface. In addition, the matching portion refers to a point cloud corresponding to an individual object, which is detected by the detection means 26. In the identification system 2, the monitoring setting means 23 sets the target of monitoring to the above-described matching portion.

Next, an example of operations of the identification system 2 is explained with reference to FIG. 7. As illustrated in FIG. 7, the identification system 2 performs processes of S101 to S108. The identification system 2 performs processes of S101 to S106 among these processes in a manner similar to the identification system 1. The identification system 2 differs from the identification system 1 in that the identification system 2 performs the processes of S201 and S202.

The detection means 26 detects a matching portion that satisfies a condition according to a predetermined shape from among positions other than the moving object position among the positions where the laser reflected light is reflected (S201). The monitoring setting means 23 sets the target of monitoring to the matching portion (S202). The monitoring means 25 monitors the position that is set as the target of monitoring (S108). In the process of S108, the matching portion is monitored.

The identification system 2 has been hereinabove explained. Since the identification system 2 has the same configuration as the identification system 1, the moving objects can be excluded from the target of monitoring. As a result, in monitoring of the stationary structure 400, noise corresponding to the moving object can be restrained from being mixed into the result of monitoring. Furthermore, by including stationary objects in the target of monitoring, monitoring of the stationary structures 400 can be realized.

The identification system 2 further includes the detection means 26 that detects a matching portion that satisfies a condition according to a predetermined shape from among positions other than the moving object position. Therefore, the monitoring setting means 23 can individually set the target of monitoring for each shape (for example, an individual shape of an object) corresponding to the matching portion.

### Third Example Embodiment

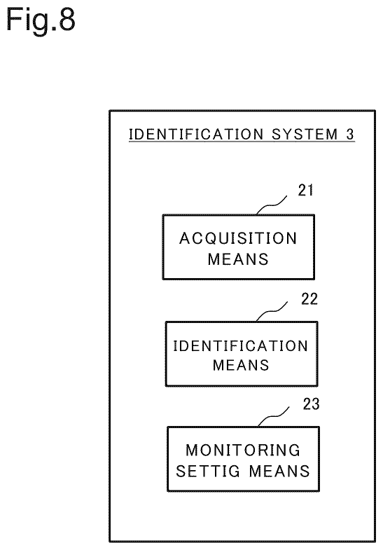

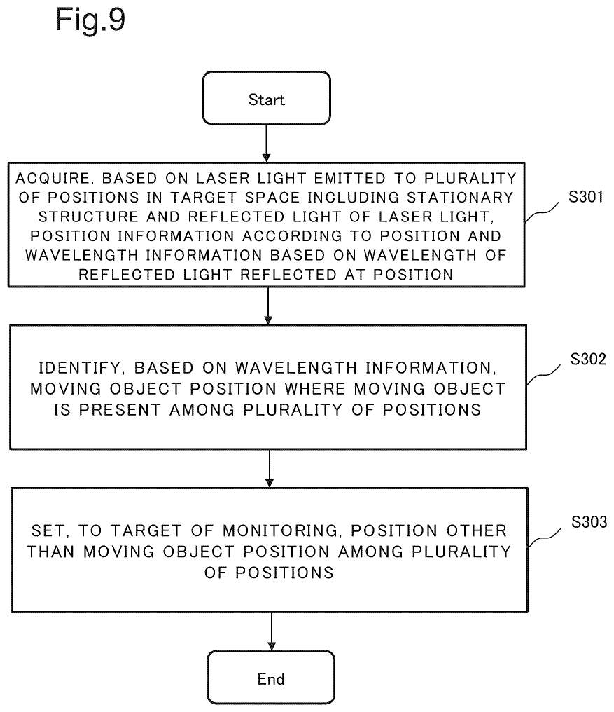

An identification system 3 according to the third example embodiment is explained with reference to FIG. 8 and FIG. 9. FIG. 8 is a block diagram illustrating a configuration example of the identification system 3. FIG. 9 is a flowchart illustrating an example of operations of the identification system 3. The identification system 1 and the identification system 2 explained above are specific examples of the identification system 3.

As illustrated in FIG. 8, the identification system 3 includes acquisition means 21, identification means 22, and monitoring setting means 23. It is assumed that the light source unit 10 (not illustrated) is provided outside the identification system 3, and that communication with the identification system 3 is possible. The acquisition means 21, the identification means 22, and the monitoring setting means 23 of the identification system 3 may have functions and connection relationships similar to the acquisition means 21, the identification means 22, and the monitoring setting means 23 of the identification system 1, 2.

The acquisition means 21 acquire, based on the laser light and the reflected light of the laser light emitted to plurality of positions in the target space including the stationary structure, position information according to the position and the wavelength information based on the wavelength of the reflected light reflected at the position.

The identification means 22 identifies, based on the wavelength information, the moving object position where the moving object is present from among plurality of positions where the laser light is reflected.

The monitoring setting means 23 sets the target of monitoring to a position other than the moving object position from among plurality of positions.

Next, an example of operations of the identification system 3 is explained with reference to FIG. 9. The example of the operations below corresponds to an identification method. Furthermore, a storage medium may store a program for causing an information processing apparatus to execute processes of the example of the operations below.

The acquisition means 21 acquires, based on the laser light and the reflected light of the laser light emitted to plurality of positions in the target space including the stationary structure, position information according to the position and the wavelength information based on the wavelength of the reflected light reflected at the position (S301).

The identification means 22 identifies, based on the wavelength information, the moving object position where the moving object is present from among plurality of positions where the laser light is reflected (S302).

The monitoring setting means 23 sets the target of monitoring to a position other than the moving object position from among plurality of positions (S303).

The identification system 3 has been hereinabove explained. In the identification system 3, the acquisition means 21 acquires, based on the reflected light of the laser light emitted to each position in the target space including the stationary structure, position information corresponding to each position and the wavelength information based on the wavelength of reflected light reflected at each position. Furthermore, the identification means 22 identifies, based on the wavelength information, the moving object position where the moving object is present from among plurality of positions where the laser light is reflected. Furthermore, the monitoring setting means 23 sets the target of monitoring to a position other than the moving object position from among the plurality of positions where the laser light is reflected.

As described above, according to the identification system 3, moving objects can be excluded from the target of monitoring. As a result, in monitoring of the stationary structure, noise corresponding to the moving object can be restrained from being mixed into the result of monitoring. Furthermore, by including stationary objects in the target of monitoring, monitoring of the stationary structures can be realized.

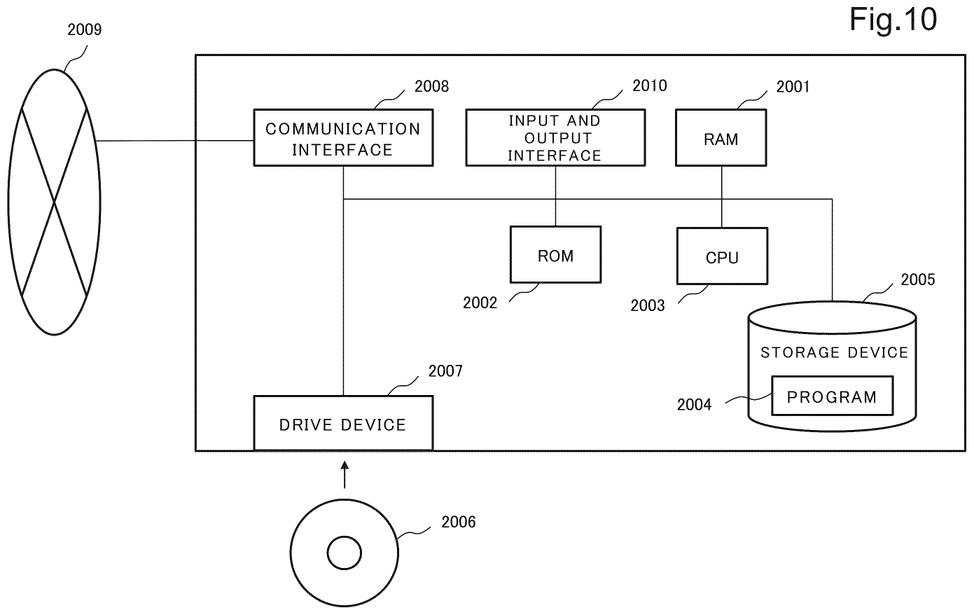

Further, some or all of the constituent elements of each apparatus or system is realized by an arbitrary combination of an information processing apparatus 2000 and a program as illustrated in FIG. 10, for example. FIG. 10 is a diagram illustrating an example of an information processing apparatus that implements the identification systems 1, 2, 3, and the like. The information processing apparatus 2000 includes the following configuration, for example.
Central Processing Unit (CPU) 2001
Read Only Memory (ROM) 2002
Random Access Memory (RAM) 2003
program 2004 loaded to RAM 2003
Storage device 2005 storing program 2004
Drive device 2007 reading and writing recording medium 2006
Communication interface 2008 connecting to communication network 2009
Input and output interface 2010 for inputting and outputting data
Bus 2011 connecting constituent elements

The constituent elements of each apparatus according to each example embodiment is realized by the CPU 2001 acquiring and executing the program 2004 that realizes these functions. The program 2004 that realizes the functions of the constituent elements of each apparatus is stored in advance in the storage device 2005 or RAM 2003, for example, and is read out by the CPU 2001 as needed. It should be noted that the program 2004 may be supplied to the CPU 2001 via the communication network 2009, or may be stored in the recording medium 2006 in advance, and the drive device 2007 may read out the program and supply it to the CPU 2001.

There are various modified example embodiments for the implementation method of each apparatus. For example, each apparatus may be realized by any combination of a separate information processing apparatus 2000 and a program for each constituent element.

Furthermore, plurality of constituent elements included in each apparatus may be realized by an arbitrary combination of one information processing apparatus 2000 and a program.

In addition, some or all of the constituent elements of each apparatus are realized by general-purpose or dedicated circuitry, including a processor, or a combination thereof. These may be composed of a single chip or plurality of chips connected via a bus. Some or all of the constituent elements of each apparatus may be realized by a combination of the above-mentioned circuitry and the like and a program.

In a case where some or all of the constituent elements of each apparatus is realized by plurality of information processing apparatuses, circuitry, and the like, the plurality of information processing apparatuses, circuitry, and the like may be centrally located or distributed. For example, the information processing apparatuses, circuitry, and the like may be realized as a client-and-server system, a cloud computing system, and the like, in which each is connected via a communication network.

Some or all of the above example embodiments may be described as in the following Supplementary Notes, but are not limited thereto.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### REFERENCE SIGNS LIST

1, 2 Identification system
10 Light source unit
11 Light emission means
13 Light receiving means
20 Identification apparatus
21 Acquisition means
22 Identification means
23 Monitoring setting means
24 Point cloud data generating means
25 Monitoring means
26 Detection means
2001 CPU
2002 ROM
2003 RAM
2004 Program
2005 Storage device
2007 Drive device
2008 Communication interface
2009 Communication network
2010 Input and output interface
2011 Bus connecting constituent elements

What is claimed is:

1. An identification system comprising:
an acquisition circuit configured to acquire, based on laser light emitted to a plurality of positions within a target space including a stationary structure and reflected light of the laser light, position information according to the positions and wavelength information based on a wavelength of the reflected light reflected at the plurality of positions;
an identification circuit configured to identify, based on the wavelength information, a moving object position where a moving object is present among the plurality of positions; and
a monitoring setting circuit configured to set, to a target of monitoring, the positions other than the moving object position among the plurality of positions.

2. The identification system according to claim 1, further comprising a point cloud data generator configured to generate point cloud data being a set of points associated with the positions other than the moving object position, among the plurality of positions.

3. The identification system according to claim 1, wherein the acquisition circuit acquires the wavelength information according to a difference between the wavelength of the reflected light and a wavelength of the laser light.

4. The identification system according to claim 1, further comprising a detector configured to detect a matching portion that satisfies a condition according to a predetermined shape among the positions other than the moving object position,
wherein the monitoring setting circuit sets the matching portion to a target of monitoring.

5. The identification system according to claim 1, further comprising a monitor configured to monitor the position being set as the target of monitoring.

6. An identification method comprising:
acquiring, based on laser light emitted to a plurality of positions within a target space including a stationary structure and reflected light of the laser light, position information according to the positions and wavelength information based on a wavelength of the reflected light reflected at the positions;
identifying, based on the wavelength information, a moving object position where a moving object is present among the plurality of positions; and
setting, to a target of monitoring, the positions other than the moving object position among the plurality of positions.

7. A tangible and non-transitory storage medium storing a program that causes an information processing apparatus to execute:
processing of acquiring, based on laser light emitted to a plurality of positions within a target space including a stationary structure and reflected light of the laser light, position information according to the positions and wavelength information based on a wavelength of the reflected light reflected at the positions;
processing of identifying, based on the wavelength information, a moving object position where a moving object is present among the plurality of positions; and
processing of setting, to a target of monitoring, the positions other than the moving object position among the plurality of positions.
